(19) United States
(12) Patent Application Publication
(10) Pub. No.: US 2014/0370792 A1
(43) Pub. Date: Dec. 18, 2014

(54) POWER TOOL

(71) Applicant: Rostfach Bosch GmbH, Stuttgart (DE)

(72) Inventors: Cornelius Boeck, Kirchheim (DE); Daniel Barth, Leinfelden-Echterdingen (DE); Sinisa Andrasic, Schoenaich (DE); Joachim Schadow, Stuttgart (DE)

(21) Appl. No.: 14/368,002

(22) PCT Filed: Nov. 15, 2012
(86) PCT No.: PCT/EP2012/072761

§ 371 Date: Jun. 23, 2014

(30) Foreign Application Priority Data
Dec. 23, 2011 (DE) 10 2011 089 726.7

(51) Int. Cl. H01H 3/20; H01H 9/06; H01H 21/10; B24B 23/02

(52) U.S. Cl. CPC H01H 3/20; B24B 23/028; H01H 9/06; H01H 21/10
USPC 451/359

(57) ABSTRACT

A power tool, especially an angle grinder, includes at least one grip housing, at least one switching unit that has at least one latch element arranged on the grip housing, and at least one bearing unit configured to mount the latch element such that it is mobile at least with respect to the grip housing. When the latch element is actuated, the bearing unit is configured to guarantee a stroke movement of the latch element along a trajectory of a value greater zero, starting from an end of the latch element closer to the connecting region of the grip housing in the direction of an end of the latch element away from the connecting region, which end is configured to be gripped.

### PRIOR ART

Already known from DE 197 07 215 A1 is a power tool, in particular an angle grinder, which comprises a handle housing, a switching unit that has a latch element arranged on the handle housing, and which comprises a bearing unit, which is provided for mounting the latch element so as to be at least movable relative to the handle housing.

### DISCLOSURE OF THE INVENTION

The invention is based on a power tool, in particular an angle grinder, comprising at least one handle housing, comprising at least one a switching unit that has at least one latch element arranged on the handle housing, and comprising at least one bearing unit, which is provided for mounting the latch element so as to be at least movable relative to the handle housing.

It is proposed that the bearing unit be provided to ensure a travel movement of the latch element along a distance having a value of greater than zero in every case, upon an actuation of the latch element, starting from an end of the latch element that faces toward a connecting region of the handle housing, in the direction of a further end of the latch element that can be gripped and that faces away from the connecting region. The power tool is preferably realized as a portable power tool, in particular as a portable, hand-held power tool. A “portable power tool” is to be understood here to mean, in particular, a power tool, for performing work on workpieces, that can be transported by an operator without the use of a transport machine. The portable power tool has, in particular, a mass of less than 40 kg, preferably less than 10 kg, and particularly preferably less than 7 kg. Particularly preferably, the portable power tool is realized as an angle grinder. It is also conceivable, however, for the portable power tool to be of a different design, considered appropriate by persons skilled in the art, such as, for example, designed as a hammer drill and/or chipping hammer, power drill, saber saw, compass saw, hedge shears, etc.

A “handle housing” is to be understood here to mean, in particular, at least one housing or at least one housing sub-region that, to a large extent, is dissociated from a mounting of a drive unit and/or output unit of the power tool, wherein at least one grip region of the housing or of the housing sub-region, in particular a housing sub-region realized as a stem-type grip region, can be gripped by an operator, by at least one hand, at least to a large extent, for the purpose of handling the power tool. The expression “can be gripped to a large extent” is intended here to define, in particular, a capability whereby a component or a component region can be gripped by a hand of an operator along at least more than 70%, preferably more than 80%, and particularly preferably more than 90% of a total extent of a total outer circumference of the component or of the component region that runs in a plane extending at least substantially perpendicularly in relation to a direction of longitudinal extent of the component or of the component region, wherein the total extent of the total circumference is, in particular, less than 40 cm, preferably less than 30 cm, and particularly preferably less than 25 cm. Preferably, when the component or component region is gripped, a hand inner surface and finger inner surfaces of the hand of the operator bear on the total outer circumference at least along a distance greater than 70%, preferably greater than 80%, and particularly preferably greater than 90% of the total extent of the total outer circumference. Preferably, the handle housing is realized so as to be separate from a drive housing of the power tool that is provided to accommodate the drive unit and/or output unit, in order to support drive bearing forces and/or output bearing forces. It is also conceivable, however, for the handle housing and the drive housing to be realized as a single piece.

Preferably, the handle housing has a stem-type grip region. The expression “stem-type grip region” is intended here to define, in particular, a housing sub-region of the handle housing that, as viewed in a longitudinal sectional plane, in which the direction of main extent of the power tool extends, along a direction running at least substantially perpendicularly in relation to the direction of main extent, has a maximum extent, in particular, of less than 10 cm, preferably of less than 8 cm, and particularly preferably of less than 6 cm, wherein at least one operating surface of the handle housing is arranged in the housing sub-region of the handle housing. Preferably, the maximum extent, as viewed in the longitudinal sectional plane, is delimited by at least two parallel straight lines, or by at least two straight lines, inclined relative to each other by an angle of less than 10°, preferably of less than 8°, and particularly preferably of less than 6°, that are constituted by an outer contour of the housing sub-region of the handle housing. The stem-type grip region is inclined relative to a direction of main extent of the power tool, in particular, at least by an angle of less than 60°, preferably of less than 40°, and particularly preferably of less than 30°.

Preferably, the stem-type grip region, as viewed along a rotation axis of a drive element, in particular of an armature shaft, a drive unit of the power tool, and in particular along the direction of main extent of the power tool, is arranged behind the drive unit.

Moreover, it is conceivable for the handle housing, in addition to having the stem-type grip region, to have a bow-shaped sub-region, which is integrally formed on to the stem-type grip region. The bow-shaped sub-region may preferably be of an L-shaped design, which extends in an L shape in the direction of the connecting region, starting from an end of the stem-type grip region that faces away from the connecting region of the handle housing. Particularly preferably, the handle housing comprises at least two handle housing shell elements, which can be joined to each other in a joint plane. The handle housing thus preferably has a shell-type structure. It is also conceivable, however, for the handle housing to have a pot-type structure.

The term “switching unit” is intended there to define, in particular, a unit having at least one component, in particular the latch element, which can be actuated directly by an operator, and which is provided to influence and/or alter a process and/or a state of a unit coupled to the switching unit, through an actuation and/or through an input of parameters. The latch element is preferably provided for actuating at least one switching element of the switching unit. A “latch element” is to be understood here to mean, in particular, an operating element that, along a direction of longitudinal extent of the operating element, has a longitudinal extent that is greater than a transverse extent of the operating element that runs at least substantially perpendicularly in relation to the direction of longitudinal extent and runs at least substantially transversely in relation to a main direction of movement of the operating element. “Substantially transversely” is to be understood here to mean, in particular, an alignment of a direction and/or of an axis relative to a reference direction and/or to a reference axis, wherein the alignment of the direction and/or of the axis are at least different from an at least substantially parallel alignment in relation to the reference direction and/or to the reference axis and, in particular, are askew or perpendicular in relation to the reference direction and/or to the reference axis. Preferably, a maximum longitudinal extent of the latch element is at least 2 times greater, preferably at least 4 times greater, and particularly preferably at least 6 times greater than a maximum transverse extent of the latch element. The latch element has, in particular, a maximum longitudinal extent that is greater than 3 cm, preferably greater than 6 cm, and particularly preferably greater than 8 cm. In addition, the latch element preferably comprises an operating surface, in particular an operating surface constituted by a grip surface region of the latch element, on which an operator can place at least three fingers in order to actuate the latch element, and which has at least one longitudinal extent that is greater than 5 cm, running along the direction of longitudinal extent of the latch element.

The expression “substantially perpendicularly” is intended here to define, in particular, an alignment of a direction relative to a reference direction, wherein the direction and the reference direction, in particular as viewed in one plane, enclose an angle of 90° and the angle has a maximum deviation of, in particular, less than 8°, advantageously less than 5°, and particularly advantageously less than 2°. Preferably, the switching unit is provided to actuate the switching element by means of an actuation of the latch element, in order to open or close an electric circuit for supplying energy, at least to a drive unit of the power tool. The switching unit is thus preferably provided to enable the power tool to be put into operation or deactivated. “Provided” is to be understood to mean, in particular, specially designed and/or specially equipped. The switching element is preferably constituted by a mechanical, electrical and/or electronic switching element.

The term “bearing unit” is intended here to define, in particular, a unit provided to limit a number of degrees of freedom of movement of at least one component, wherein the unit has at least one bearing element that enables the component to be moved in a guided manner along and/or about at least one movement axis of the component. The bearing unit in this case may be realized as a translational bearing unit and/or as a rotational bearing unit. Particularly preferably, the bearing unit is realized as a rotational bearing unit. Moreover, the expression “connecting region” is to be understood here to mean, in particular, a region of the handle housing via which the handle housing is connected to the drive housing in a form closed, force closed and/or materially bonded manner, or by means of which the handle housing bears directly against the drive housing. An “end of the latch element that faces toward the connecting region” is to be understood here to mean, in particular, an arrangement of points of the latch element, in respect of a central plane of the latch element, that runs at least substantially perpendicularly in relation to the direction of longitudinal extent of the latch element, and that is arranged at least substantially equally from two ends of the latch element that are spaced apart from each other along the direction of longitudinal extent of the latch element, wherein all points of the latch element, that are arranged, starting from the central plane, in the direction of the connecting region, as viewed along the direction of longitudinal extent of the latch element, are considered to face toward the connecting region. Thus, preferably, all points of the latch element that are arranged, starting from the central plane of the latch element, along a direction away from the connecting region, as viewed along the direction of longitudinal extent of the latch element, are considered to face away from the connecting region. It is conceivable in this case for the end of the latch element that faces toward the connecting region to be dissociated from a travel movement in a bearing point at which at least one bearing element of the bearing unit is arranged on the latch element. Preferably, the end of the latch element that faces toward the connecting region executes a travel movement along a distance that, in particular, is greater than 0.5 mm, preferably greater than 1 mm, and particularly preferably greater than 2 mm, in particular in the bearing point, as a result of an actuation.

An “end that can be gripped” is to be understood here to mean, in particular, an end of the latch element, as viewed along the direction of longitudinal extent of the latch element, in particular an end of the operating surface of the latch element, that projects out of the handle housing, in particular along a direction running at least substantially perpendicularly in relation to the direction of longitudinal extent of the latch element, and that can be contacted directly by an operator for the purpose of actuating the latch element. Particularly preferably, the latch element executes a travel movement in the direction of the handle housing as a result of an actuation. In particular, the latch element executes a travel movement in the direction of the handle housing over an at least substantially full longitudinal extent of an operating surface of the latch element. By means of the design of the power tool according to the invention, advantageously, the latch element can be operated along an at least substantially full longitudinal extent of the latch element, in particular along an at least substantially full longitudinal extent of an operating surface of the latch element. A high degree of operating comfort can thus be achieved.

Furthermore it is proposed that the bearing unit have at least one bearing element that is arranged at the end of the latch element that faces toward the connecting region of the handle housing. Preferably, the latch element is mounted so as to be movable at least along and/or about a movement axis of the latch element that runs through the bearing element. Particularly preferably, the latch element is mounted so as to be pivotable about the movement axis that runs through the bearing element. The movement axis of the latch element is thus preferably realized as a pivot axis. The pivot axis preferably runs at least substantially perpendicularly in relation to the direction of longitudinal extent of the latch element. The pivot axis in this case preferably runs at least substantially parallelwise in relation to the central plane of the latch element. The design according to the invention makes it possible, advantageously, to achieve comfortable operation of the latch element at the end of the latch element that faces away from the connecting region of the handle housing.

Advantageously, the bearing unit has at least one bearing element that is arranged on a side of an actuating region of a switching element of the switching unit that faces toward the connecting region of the handle housing. The switching element is preferably actuated via the latch element. The actuating region is preferably constituted by a switching tappet of the switching element. Particularly advantageously, the mounting of the latch element according to the invention makes it possible to use a lever principle, in order to achieve a small switch-on force. Moreover, advantageously, owing to the arrangement of the bearing element according to the invention, a large switch-on travel of the latch element can be achieved for actuating the switching element.

It is additionally proposed that the bearing unit have at least one bearing element that is realized as a pin-type bearing element. “Pin-type” is to be understood here to mean, in particular, a geometric design of an element, in particular of the bearing element, wherein the element has a longitudinal extent that is greater than a transverse extent running perpendicularly in relation to the longitudinal extent. Preferably, the bearing element is realized so as to be rotationally symmetrical about at least one axis. Preferably, the axis about which the bearing element is realized so as to be rotationally symmetrical is constituted by the pivot axis of the latch element. It is also conceivable, however, for the bearing element to be of a different design, considered appropriate by persons skilled in the art. Advantageously, the design according to the invention makes it possible to achieve a structurally simple bearing element for mounting the latch element.

Particularly preferably, the pin-type bearing element is realized so as to be integral with the handle housing. “Integral with” is to be understood to mean, in particular, connected at least in a materially bonded manner, for example by a welding process, an adhesive process, an injection process and/or another process considered appropriate by persons skilled in the art, and/or, advantageously, formed in one piece such as, for example, by being produced from a casting and/or by being produced in a single or multi-component injection process and, advantageously, from a single blank. Advantageously, savings can be achieved in components, structural space and costs.

Furthermore, it is proposed that the bearing unit comprise at least one lever mechanism unit. A “lever mechanism unit” is to be understood here to mean, in particular, a unit provided to convert at least one translational movement of an element, in particular of the latch element, as a result of an actuation by an operator, into a rotational movement of the element about at least one axis, wherein the unit preferably has at least one rod-shaped bearing element that is movably arranged on the element to be moved. Preferably, the lever mechanism unit is realized as a coupler mechanism unit. Advantageously, it is possible to achieve exact guidance of the latch element during a movement as a result of an actuation of the latch element.

Particularly preferably, the lever mechanism unit is realized as a parallelogram lever mechanism unit. A “parallelogram lever mechanism unit” is to be understood here to mean, in particular, a unit that keeps at least substantially constant an alignment of the operating surface relative to the handle housing, upon a movement of the latch element, in particular upon a movement about the pivot axis of the latch element, relative to the handle housing. Preferably, bearing elements of the parallelogram lever mechanism unit constitute a parallelogram-type arrangement, in the case of a notional, rectilinear connection of the bearing elements to each other, in particular as viewed in a plane. Thus, advantageously, a uniform travel movement can be achieved, over the entire operating surface of the latch element, in the direction of the handle housing, as a result of an actuation of the latch element. Advantageously, it is thus possible to achieve comfortable operation of the latch element.

It is additionally proposed that the bearing unit comprise at least the lever mechanism unit, which has at least one lever bearing element that actuates an actuating region of a switching element of the switching unit in dependence on a movement of the latch element. Preferably, the lever bearing element is realized as a lever having a respective bearing recess at two ends of the lever bearing element that face away from each other. The lever bearing element is preferably connected, by one end, to a bearing element of the bearing unit that is arranged in the handle housing. The lever bearing element preferably actuates the actuating region, realized as a switching tappet, of the switching element, in dependence on a movement of the latch element, for the purpose of putting the power tool into operation. Advantageously, a saving in components can be realized for the actuation of the switching element, in that the lever bearing element can assume a bearing function and an actuating function.

Advantageously, the bearing unit comprises at least the lever mechanism unit, which has at least one lever bearing element that is movably connected to the latch element, at the end of the latch element that faces toward the connecting region of the handle housing. It is thereby possible to achieve a rotation point arranged outside of the latch element, such that an advantageous lever ratio can be achieved.

Particularly preferably, the lever mechanism unit has at least one further lever bearing element, which is arranged in a movable manner on the latch element, and in a movable manner on a further bearing element of the bearing unit that is arranged on a side of an actuating region of a switching element of the switching unit that faces toward the connecting region of the handle housing. The arrangement according to the invention, and a combined action of the lever bearing element and of the further lever bearing element, enable the parallelogram lever mechanism unit to be realized through simple design means.

Furthermore, it is proposed that the bearing unit have at least one movement guide element, which comprises at least one movement guide path having a course that is different from a pure rectilinear course. A “pure rectilinear course” is to be understood here to mean, in particular, a course of the movement path that is dissociated from bends and/or curves, in particular as viewed along a total extent of the movement guide path. A “course of a movement guide path” is to be understood here to mean, in particular, a course of a path that defines a movement path of the latch element during a movement, wherein the course of the path is constituted by edge regions of the movement guide element that are at least substantially parallel to each other and delimit the path. The movement guide element is preferably arranged on the latch element. Advantageously, owing to the fact that the course of the movement guide path of the movement guide element is different from a pure rectilinear course, the design of the movement guide element according to the invention makes it possible to achieve a change of direction of a movement of the latch element, as a result of an actuation of the latch element.

Advantageously, the bearing unit has at least one movement guide element that comprises at least one movement guide path having an L-shaped course. The design according to the invention enables a mechanical switch-on inhibitor of the latch element to be achieved through simple design means.

Particularly preferably, the bearing unit has at least one movement guide element that comprises at least one movement guide path having at least one limb that extends at least substantially transversely in relation to a direction of longitudinal extent of the latch element. Preferably, in this case the limb of the movement guide path and the direction of longitudinal extent of the latch element enclose an angle that is greater than 10°, preferably greater than 20°, and particularly preferably greater than 50°. Through simple design means, it is possible to achieve a movement of the latch element, running at least substantially transversely in relation to the direction of longitudinal extent of the latch element, and guided by means of the movement path, as a result of an actuation of the latch element, in order to achieve a travel movement of the latch element along the at least substantially entire extent of the operating surface of the latch element.

It is additionally proposed that the bearing unit have at least one movement guide unit that is provided to act in combination with a bearing element of the bearing unit that engages in a movement guide path of the movement guide element, in order to guide the latch element during a movement. Preferably, the bearing element is realized as a pin-type bearing element.

Preferably, the bearing element is arranged on the inside of the handle housing that faces toward the latch element. Preferably, the bearing element is integrally formed on to the handle housing. It is also conceivable, however, for the bearing element to be realized separately from the handle housing, and to be fixedly connected to the handle housing by means of a type of connection considered appropriate by persons skilled in the art, such as, for example, a form closure and/or force closure type of connection. In addition, however, it is also conceivable for the bearing element to be arranged on the latch element, and for the movement guide element to be arranged on the inside of the handle housing. The design according to the invention makes it possible to achieve an inexpensive and structurally simple guidance of the latch element.

Advantageously, the movement guide path of the movement guide element is realized as a guide slot. It is also conceivable, however, for the movement guide path to be of a different design, considered appropriate by persons skilled in the art, such as, for example, a web-type design, a design as a magnetic guide path, etc. A reliable guidance of the latch element during a movement of the latch element can be achieved through simple design means.

Particularly preferably, the movement guide element is realized so as to be integral with the latch element. It is also conceivable, however, for the movement guide element to be realized separately from the latch element, and to be fixedly connected to the latch element by means of a type of connection considered appropriate by persons skilled in the art, such as, for example, a form closure and/or force closure type of connection. Owing to the integral design of the movement guide element and the latch element, savings can be made, advantageously, in components, structural space and costs.

Furthermore, it is proposed that the bearing unit be provided to enable at least one pivot movement, of the further end of the latch element that can be gripped and that faces away from the connecting region, into the handle housing. It is thus possible, advantageously, to achieve comfortable operation of the latch element at the end of the latch element that faces away from the latch element, for the purpose of actuating the switching element.

It is additionally proposed that the switching unit have at least one spring element, which is provided to apply a spring force of the spring element to the latch element, in the direction of an initial position. A “spring element” is to be understood to mean, in particular, a macroscopic element having at least one extent that, in a normal operating state, can be varied elastically by at least 10%, in particular by at least 20%, preferably by at least 30%, and particularly advantageously by at least 50% and that, in particular, generates a counter-force, which is dependent on a variation of the extent and preferably proportional to the variation and which counteracts the variation. An “extent” of an element is to be understood to mean, in particular, a maximum distance of two points of a perpendicular projection of the element on to a plane. A “macroscopic element” is to be understood to mean, in particular, an element having an extent of at least 1 mm, in particular of at least 5 mm, and preferably of at least 10 mm. Preferably, the spring element is constituted by a spring element of the switching element that applies a spring force to a switching tappet of the switching element.

Advantageously, by means of the spring element, a dead man's circuit of the switching unit can be achieved. Thus, advantageously, it is possible to achieve a high degree of safety against the power tool being unintentionally put into operation.

The invention is additionally based on a power switching device for a power tool according to the invention, wherein the power tool switching device comprises at least the switching unit and at least the bearing unit. Thus, advantageously, already existing power tools can easily be retrofitted with the switching unit and the bearing unit according to the invention.

The power tool according to the invention and/or the power tool switching device according to the invention are/is not intended in this case to be limited to the application and embodiment described above. In particular, the power tool according to the invention and/or the power tool switching device according to the invention may have individual elements, components and units that differ in number from a number stated herein, in order to fulfill a principle of function described herein.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a power tool according to the invention, in a schematic representation,

FIG. 2 shows a detail view of a switching unit of the power tool according to the invention and of a bearing unit of the power tool according to the invention, when mounted in a handle housing of the power tool according to the invention, with the switching unit in an unactuated state, in a schematic representation,

FIG. 3 shows a detail view of the switching unit and of the bearing unit from FIG. 2, when mounted in the handle housing, with the switching unit in an actuated state, in a schematic representation,

FIG. 4 shows a detail view of a latch element of the switching unit arranged on the handle housing, in a schematic representation,

FIG. 5 shows a further detail view of the latch element arranged on the handle housing, in a schematic representation,

FIG. 6 shows a detail view of a switching unit of an alternative power tool according to the invention and of a bearing unit of the alternative power tool according to the invention, when mounted in a handle housing of the alternative power tool according to the invention, with the switching unit in an unactuated state, in a schematic representation,

FIG. 7 shows a detail view of the switching unit and of the bearing unit from FIG. 5, when mounted in the handle housing, with the switching unit in an actuated state, in a schematic representation,

FIG. 8a shows a detail view of a latch element of the switching unit from FIG. 5 arranged on the handle housing, in an unactuated state, in a schematic representation,

FIG. 8b shows a detail view of the latch element from FIG. 5 arranged on the handle housing, in an unlocking position, in a schematic representation, and

FIG. 8c shows a detail view of the latch element of the switching unit from FIG. 5 arranged on the handle housing, in a fully actuated state, in a schematic representation.

### DESCRIPTION OF THE EXEMPLARY EMBODIMENTS

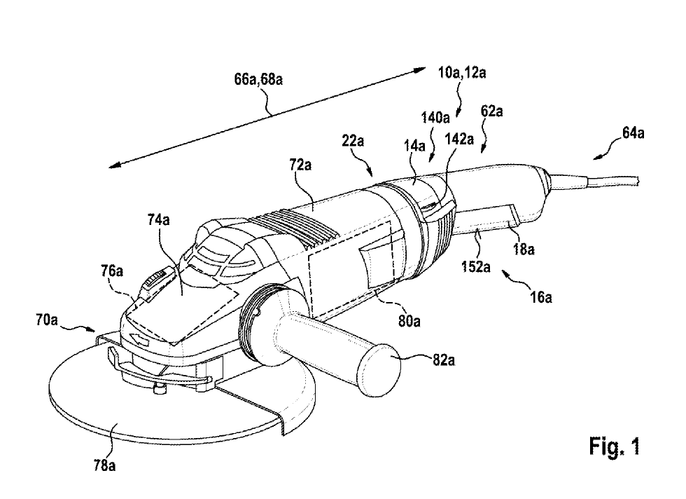

FIG. 1 shows a power tool 10a, which is constituted by a portable power tool 10a realized as an angle grinder 12a. The portable power tool 10a comprises at least one handle housing 14a, at least one switching unit 16a, which has at least one latch element 18a, arranged on the handle housing 14a, for actuating a switching element 36a of the switching unit 16a, and at least one bearing unit 20a, which is provided to mount the latch element 18a so as to be at least movable relative to the handle housing 14a. The portable power tool 10a in this case has at least one power tool switching device, which comprises at least the switching unit 16a and at least the bearing unit 20a for mounting the latch element 18a of the switching unit 16a in a movable manner. The bearing unit 20a is provided to ensure a travel movement of the latch element 18a along a distance having a value of greater than zero in every case, upon an actuation of the latch element 18a, starting from an end 24a of the latch element 18a that faces toward a connecting region 22a of the handle housing 14a, in the direction of a further end 26a of the latch element 18a that can be gripped and that faces away from the connecting region 22a. The handle housing 14a in this case comprises a stem-type grip region 62a, on which the latch element 18a is arranged. The stem-type grip region 62a of the handle housing 14a constitutes a main handle of the portable power tool 10a. In this case, the main handle constituted by the stem-type grip region 62a extends, at least substantially, starting from a connecting region 22a of the main handle housing 14a, in a direction away from the connecting region 22a, as far as a side 64a of the handle housing 14a on which there is arranged a cable of the portable power tool 10a, realized as an angle grinder 12a, for supplying energy. The stem-type grip region 62a of the handle housing 14a is offset relative to a direction of main extent 66a of the handle housing 14a, or relative to a direction of main extent 68a of the portable power tool 10a, by an angle of less than 30°.

The portable power tool 10a, realized as an angle grinder 12a, additionally comprises a protective cover unit 70a, a drive housing 72a and an output housing 74a. Extending out from the output housing 74a there is an output shaft of an output unit 76a of the portable power tool 10a, which is realized as a spindle (not represented in greater detail here), to which a working tool 78a can be fixed, for performing work on a workpiece (not represented in greater detail here). The working tool 78a is realized as an abrasive disk. It is also conceivable, however, for the working tool 78a to be realized as a parting disk or polishing disk. The portable power tool 10a comprises the drive housing 72a, for accommodating a drive unit 80a of the portable power tool 10a, and the output housing 74a, for accommodating the output unit 76a. The drive unit 80a is provided to drive the working tool 78a in rotation, via the output unit 76a. For the purpose of performing work on a workpiece, the working tool 78a in this case may be connected to the spindle in a rotationally fixed manner by means of a fastening element (not represented in greater detail here). The working tool 78a can thus be driven in rotation when the portable power tool 10a is in operation. The output unit 76a is connected to the drive unit 80a via a drive element (not represented in greater detail here) of the drive unit 80a that is realized as a pinion gear and that can be driven in rotation, in a manner already known to persons skilled in the art. In addition, an ancillary handle 82a is arranged on the output housing 74a. When mounted on the output housing 74a, the ancillary handle 82a extends transversely in relation to the direction of main extent 68a of the portable power tool 10a.

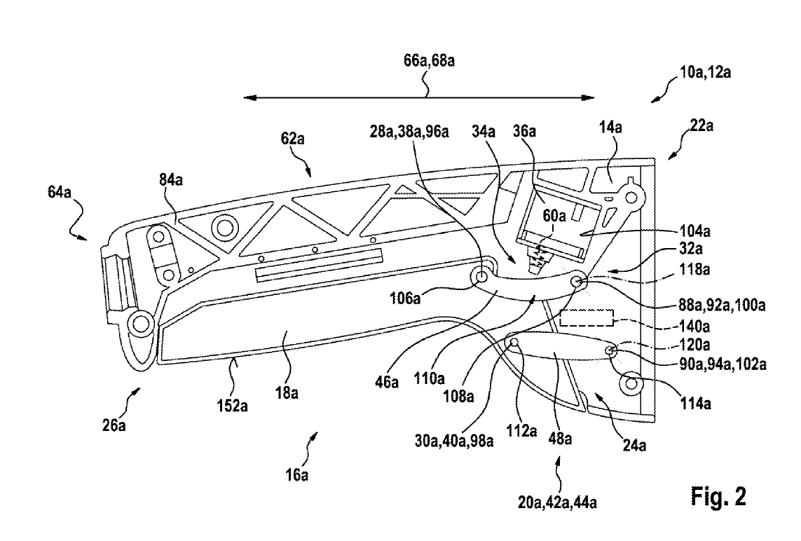

FIG. 2 shows a detail view of the switching unit 16a and of the bearing unit 20a when mounted in the handle housing 14a, with the switching unit 16a in an unactuated state, wherein one of at least two handle housing shell elements 84a, 86a of the handle housing 14a has been mounted. The bearing unit 20a has at least one bearing element 28a, which is arranged at the end 24a of the latch element 18a that faces toward the connecting region 22a of the handle housing 14a. In addition, the bearing unit 20a has at least one further bearing element 30a, which is arranged at the end 24a of the latch element 18a that faces toward the connecting region 22a of the handle housing 14a. The bearing unit 20a thus has at least two bearing elements 28a, 30a, which are arranged at the end 24a of the latch element 18a that faces toward the connecting region 22a of the handle housing 14a. The two bearing elements 28a, 30a arranged at the end 24a of the latch element 18a that faces toward the connecting region 22a are thus realized as latch bearing elements 96a, 98a. Furthermore, the bearing unit 20a has at least one bearing element 88a, which is arranged on a side 32a of an actuating region 34a of the switching element 36a of the switching unit 16a that faces toward the connecting region 22a of the handle housing 14a. In total, the bearing unit 20a has at least two bearing elements 88a, 90a, which are arranged on a side 32a of an actuating region 34a of the switching element 36a of the switching unit 16a that faces toward the connecting region 22a of the handle housing 14a. The switching element 36a is fixedly arranged in a receiving recess 104a of at least one of the handle housing shell elements 84a, 86a. The receiving recess 104a in this case, starting from the latch element 18a, as viewed along the direction of main extent 66a of the handle housing 14a in the direction of the connecting region 22a, is arranged, at least partially, after the latch element 18a, in the handle housing 14a.

In this case, the two bearing elements 88a, 90a arranged on the side 32a of the actuating region 34a of the switching element 36a that faces toward the connecting region 22a of the handle housing 14a, starting from the latch element 18a, as viewed along the direction of main extent 66a of the handle housing 14a in the direction of the connecting region 22a, are arranged after the latch element 18a, in the handle housing 14a, in at least one operating state of the latch element 18a. The two bearing elements 88a, 90a arranged on the side 32a of the actuating region 34a of the switching element 36a that faces toward the connecting region 22a of the handle housing 14a are thus realized as handle housing bearing elements 100a, 102a. The bearing elements 28a, 30a, realized as latch bearing elements 96a, 98a, and the bearing elements 88a, 90a, realized as handle housing bearing elements 100a, 102a, are each realized as pin-type bearing elements 38a, 40a, 92a, 94a. In this case, the pin-type bearing elements 38a, 40a that are realized as latch bearing elements 96a, 98a are realized so as to be integral with the latch element 18a. In addition, the pin-type bearing elements 92a, 94a that are realized as handle housing bearing elements 100a, 102a are realized so as to be integral with the handle housing 14a. It is also conceivable, however, for the pin-type bearing elements 38a, 40a, realized as latch bearing elements 96a, 98a, and the pin-type bearing elements 92a, 94a, realized as handle housing bearing elements 100a, 102a, to be realized separately from the latch element 18a, or separately from the handle housing 14a, respectively, and for each to be fixedly connected to the latch element 18a, or to the handle housing 14a, respectively, by means of a type of connection considered appropriate by persons skilled in the art, such as, for example, a form closure and/or force closure type of connection.

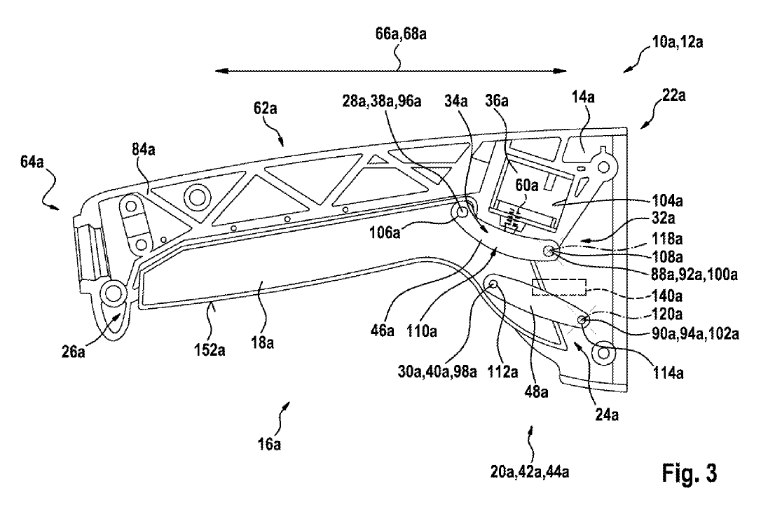

Furthermore, the bearing unit 20a comprises at least one lever mechanism unit 42a. The lever mechanism unit 42a in this case is realized as a parallelogram lever mechanism unit 44a. It is also conceivable, however, for the lever mechanism unit 42a to be of a different design, such as, for example, a design as a three-hinge coupler mechanism, as a five-hinge coupler mechanism, etc. The lever mechanism unit 42a has at least one lever bearing element 46a, which actuates an actuating region 34a of the switching element 36a of the switching unit 16a in dependence on a movement of the latch element 18a (FIG. 3). The lever bearing element 46a is movably connected to the latch element 18a at the end 24a of the latch element 18a that faces toward the connecting region 22a of the handle housing 14a. In this case, the lever bearing element 46a, which is realized as a lever, has at least two bearing recesses 106a, 108a, arranged at ends of the lever bearing element 46a that face away from each other. One of the two bearing recesses 106a, 108a is movably connected to one of the two latch bearing elements 96a, 98a. In addition, one of the two bearing recesses 106a, 108a is movably connected to one of the two handle housing bearing elements 100a, 102a. Moreover, the lever bearing element 46a is of a curved design in a sub-region 110a between the bearing recesses 106a, 108a. It is also conceivable, however, for the lever bearing element 46a, in the sub-region 110a, to be of a different design, considered appropriate by persons skilled in the art, such as, for example, a ridge-type projection, etc. The sub-region 110a is provided to actuate the actuating region 34a of the switching element 36a of the switching unit 16a in dependence on a movement of the latch element 18a.

In addition, the lever mechanism unit 42a, realized as a parallelogram lever mechanism unit 44a, has at least one further lever bearing element 48a, which is arranged in a movable manner on the latch element 18a, and in a movable manner on the further bearing element 30a, realized as a handle housing bearing element 100a, of the bearing unit 20a that is arranged on the side 32a of the actuating region 34a of the switching element 36a of the switching unit 16a that faces toward the connecting region 22a of the handle housing 14a. In this case, the further lever bearing element 48a, which is realized as a lever, has at least two bearing recesses 112a, 114a, arranged at ends of the lever bearing element 48a that face away from each other. One of the two bearing recesses 112a, 114a is movably connected to one of the two latch bearing elements 96a, 98a. In addition, one of the two bearing recesses 112a, 114a is movably connected to one of the two handle housing bearing elements 100a, 102a. The lever bearing element 46a and the further lever bearing element 48a are aligned at least substantially parallelwise in relation to each other, in respect of a rectilinear, notional connecting line of the bearing recesses 106a, 108a of the lever bearing element 46a and in respect of a rectilinear, notional connecting line of the bearing recesses 112a, 114a of the further lever bearing element 48a. Owing to the at least substantially parallel arrangement of the lever bearing element 46a and lever bearing element 48a, a parallel guidance of the latch element 18a is realized, as a result of an actuation of the latch element 18a. In this case, the further end 26a of the latch element 18a that can be gripped and that faces away from the connecting region 22a is dissociated from an arrangement of bearing points of the bearing unit 20a.

By means of the bearing unit 20a realized as a lever mechanism unit 42a, a lever ratio that is greater than 1 to 2.7 is achieved between the actuating region 34a of the switching element 36a and the latch element 18a. The lever ratio corresponds to a length of a distance, measured from the longitudinal axis of the handle housing bearing element 100a, which is connected to one of the bearing recesses 106a, 108a of the lever bearing element 46a, as far as a central axis of the actuating region 34a of the switching element 36a that is realized as a switching tappet, in relation to a length of a distance, measured from the longitudinal axis of the handle housing bearing element 100a, which is connected to one of the bearing recesses 106a, 108a of the lever bearing element 46a, as far as a longitudinal axis of the latch bearing element 96a, which is connected to one of the bearing recesses 106a, 108a of the lever bearing element 46a.

Furthermore, the switching unit 16a has at least one spring element 60a, which is provided to apply a spring force of the spring element 60a to the latch element 18a, in the direction of an initial position of the latch element 18a. The spring element 60a is provided to constitute a dead man's circuit function of the switching unit 16a. The spring element 60a is provided to enable the latch element 18a to move into an initial position of the latch element 18a, as a result of an action of a spring force upon the latch element 18a, after removal of an action of an actuating force of an operator upon the latch element 18a, in a direction away from the handle housing 14a. The spring element 60a in this case is constituted by a spring element of the switching element 36a that applies a spring force to the actuating region 34a, realized as a switching tappet, of the switching element 36a. The spring element 60a thus exerts a spring force upon the latch element 18a via the lever bearing element 46a, which actuates the actuating region 34a, realized as a switching tappet, of the switching element 36a as a result of a movement of the latch element 18a in the direction of the handle housing 14a. As a result of this, the latch element 18a, after removal of an action of an actuating force of an operator, is moved in the direction away from the handle housing 14a. It is also conceivable, however, for the switching unit 16a, in addition to or as an alternative to having the spring element 60a, to have a further spring element, which is supported on the latch element 18a and on the handle housing 14a, and which is provided to apply a spring force to the latch element 18a in the direction of an initial position of the latch element 18a.

The latch element 18a is mounted so as to be pivotable about pivot axes 118a, 120a, which go through the handle housing bearing elements 100a, 102a. The pivot axes 118a, 120a in this case constitute longitudinal axes of the handle housing bearing elements 100a, 102a, about which the handle housing bearing elements 100a, 102a are rotationally symmetrical. An alignment of an operating surface 152a of the latch element 18a relative to the handle housing 14a is maintained, at least substantially, by means of the bearing unit 20a, upon a movement of the latch element 18a relative to the handle housing 14a. By means of the bearing unit 20a, therefore, an even travel movement is achieved over then entire operating surface 152a of the latch element 18a, in the direction of the handle housing 14a, as a result of an actuation of the latch element 18a.

FIG. 4 shows a detail view of the latch element 18a of the switching unit 16a arranged on the handle housing 14a. The latch element 18a is mounted on the handle housing 14a so as to be pivotable about the pivot axes 118a, 120a of the latch element 18a. The pivot axes 118a, 120a of the latch element 18a run at least substantially perpendicularly in relation to the direction of main extent 66a of the handle housing 14a, or at least substantially perpendicularly in relation to the direction of main extent 68a of the portable power tool 10a. In this case, the pivot axes 118a, 120a run at least substantially perpendicularly in relation to a joint plane of the handle housing 14a. When in a mounted state, the two handle housing shell elements 84a, 86a of the handle housing 14a are joined together in the joint plane of the handle housing 14a. The pivot axes 118a, 120a are arranged at the end 24a of the latch element 18a that faces toward the connecting region 22a of the handle housing 14a. The latch element 18a is thus pivotally mounted at the end 24a that faces toward the connecting region 22a of the handle housing 14a.

The latch element 18a has a maximum transverse extent 122a that extends at least over a major part of at least a maximum transverse extent 124a of the stem-type grip region 62a of the handle housing 14a. In this case, the ratio of the maximum transverse extent 122a of the latch element 18a to the maximum transverse extent 124a of the stem-type grip region 62a of the handle housing 14a is at least greater than 1 to 2.5. The maximum transverse extent 122a of the latch element 18a runs along a direction that runs at least substantially perpendicularly in relation to the direction of main extent 66a of the handle housing 14a, or at least substantially perpendicularly in relation to the direction of main extent 68a of the portable power tool 10a, and at least substantially transversely at least in relation to a main direction of movement of the latch element 18a. The maximum transverse extent 122a of the latch element 18a thus runs at least substantially parallelwise in relation to the pivot axes 118a, 120a of the latch element 18a. The maximum transverse extent 124a of the stem-type grip region 62a of the handle housing 14a likewise runs along the direction that runs at least substantially perpendicularly in relation to the direction of main extent 66a of the handle housing 14a, or at least substantially perpendicularly in relation to the direction of main extent 68a of the portable power tool 10a, and at least substantially transversely at least in relation to a main direction of movement of the latch element 18a.

Furthermore, the latch element 18a has a maximum longitudinal extent 126a that extends at least over a major part of a maximum longitudinal extent 128a of the stem-type grip region 62a of the handle housing 14a. A ratio of the maximum longitudinal extent 126a of the latch element 18a to the maximum longitudinal extent 128a of the stem-type grip region 62a of the handle housing 14a is at least greater than 1 to 1.4. When the latch element 18a has been mounted on the handle housing 14a, the maximum longitudinal extent 126a of the latch element 18a extends along a direction that runs in the joint plane of the handle housing 14a, and that runs at least substantially transversely in relation to a main direction of movement of the latch element 18a. The maximum longitudinal extent 126a of the latch element 18a thus extends along a direction that runs at least substantially perpendicularly in relation to the pivot axes 118a, 120a of the latch element 18a. The maximum longitudinal extent 128a of the stem-type grip region 62a of the handle housing 14a likewise extends along the direction that runs at least substantially perpendicularly in relation to the pivot axes 118a, 120a of the latch element 18a.

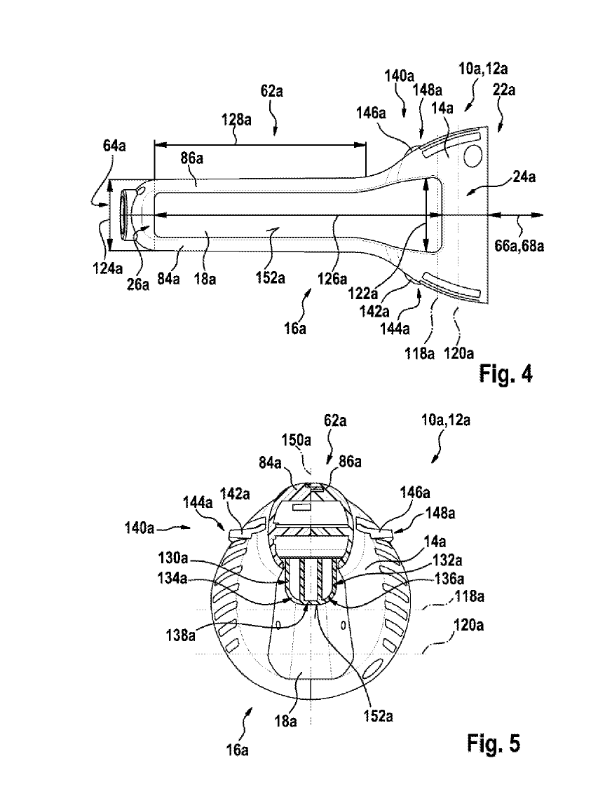

In addition, the latch element 18a has at least one side wall region 130a, which is connected, via a bow-shaped sub region 134a of the latch element 18a, to a grip surface region 138a of the latch element 18a that runs at least substantially perpendicularly in relation to the side wall region 130a, wherein a ratio of a radius of the bow-shaped sub region 134a to the maximum transverse extent 124a of the stem-type grip region 62a of the handle housing 14a is at least greater than 1 to (FIG. 5). In total, the latch element 18a has two side wall regions 130a, 132a, each of which is respectively connected, via one of the two bow-shaped sub-regions 134a, 136a of the latch element 18a, to the grip surface region 138a of the latch element 18a that runs at least substantially perpendicularly in relation to the side wall regions 130a, 132a.

The grip surface region 138a of the latch element 18a, as viewed along the direction of main extent 66a of the handle housing 14a, extends at least over a major part of the maximum longitudinal extent 126a of the latch element 18a. Moreover, the grip surface region 138a of the latch element 18a, as viewed along the direction of main extent 66a of the handle housing 14a, has an at least substantially flat course. Thus, the course of the grip surface region 138a of the latch element 18a is to a large extent dissociated from step-type offsets. It is also conceivable, however, for the grip surface region 138a of the latch element 18a to have at least one finger recess region, which is provided to receive at least one finger of a hand of an operator when the latch element 18a is being operated, or held.

Furthermore, the portable power tool 10a has at least one switch-on inhibitor unit 140a, which is provided to avoid, at least to a large extent, a movement of the latch element 18a as a result of an unintentional actuation of the latch element 18a (FIG. 1). The switch-on inhibitor unit 140a is realized as a mechanical inhibitor unit. It is also conceivable, however, for the switch-on inhibitor unit 140a to be realized as an electrical and/or electronic inhibitor unit. The switch-on inhibitor unit 140a has at least one release element 142a, which comprises an actuating region 144a that is arranged, at least partially, laterally next to one of the side wall regions 130a, 132a of the latch element 18a (FIG. 5). Moreover, the switch-on inhibitor unit 140a has at least one further release element 146a, which has an actuating region 148a that is arranged, at least partially, laterally next to one of the side wall regions 130a, 132a of the latch element 18a (FIG. 5). One of the side wall regions 130a, 132a faces toward the release element 142a, and one of the side wall regions 130a, 132a faces toward the further release element 146a.

In this case, the actuating regions 144a, 148a of the release element 142a and of the further release element 146a are arranged at a distance from the respective side wall region 130a, 132a, in each case as viewed, starting from the joint plane of the handle housing 14a, in a direction running at least substantially perpendicularly in relation to the joint plane of the handle housing 14a and away from the handle housing 14a. The release element 142a and the further release element 146a are arranged in a mirror-symmetrical manner in respect of the joint plane of the handle housing 14a. In addition, the release element 142a and the further release element 146a are mounted so as to be pivotable about a release pivot axis 150a. The release pivot axis 150a in this case runs in the joint plane of the handle housing 14a. In addition, the release pivot axis 150a runs at least substantially perpendicularly in relation to the pivot axes 118a, 120a of the latch element 18a.

In an alternative design of the portable power tool 10a, which is not represented in greater detail here, it is conceivable for the portable power tool 10a, in addition to having the switch-on inhibitor unit 140a, to have an electrical and/or electronic start-up inhibitor, which, for example, only allows the drive unit 80a to be supplied with electric power once a sensor unit of the portable power tool 10a senses a further hand of an operator having been placed on the ancillary handle 82a, in addition to a hand having been placed on the handle housing 14a, in particular on the stem-type grip region 62a, and thus deactivates the electrical and/or electronic start-up inhibitor, via an open-loop and/or closed-loop control unit of the portable power tool 10a, which evaluates and processes the characteristic quantities sensed by the sensor unit, to enable the portable power tool 10a to be put into operation.

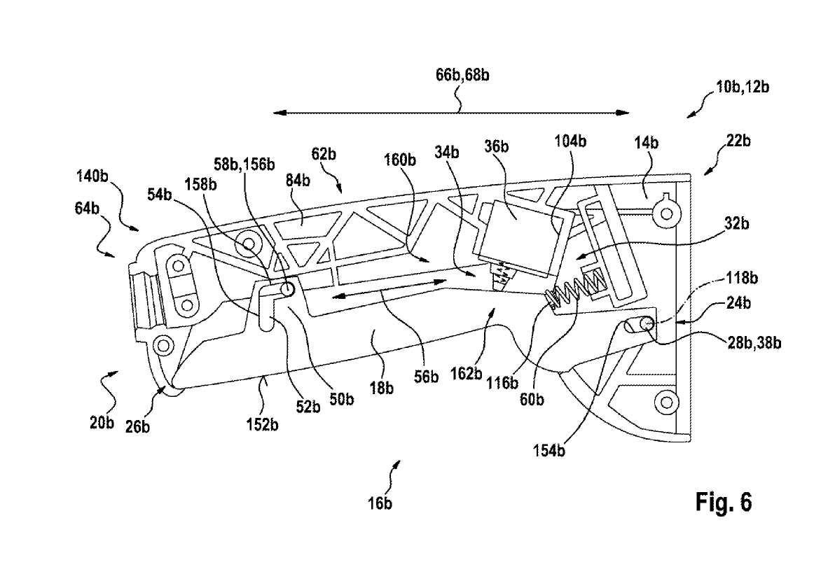

An alternative exemplary embodiment is represented in FIGS. 6 to 8c. Components, features and functions that remain substantially the same are denoted, in principle, by the same references. To differentiate the exemplary embodiments, the letters a and b have been appended to the references of the exemplary embodiments. The description that follows is limited substantially to the differences in relation to the first exemplary embodiment in FIGS. 1 to 5, and reference may be made to the description of the first exemplary embodiment in FIGS. 1 to 5 in respect of components, features and functions that remain the same.

FIG. 6 shows a detail view of a switching unit 16b of a power tool 10b that is realized as an alternative to the power tool 10a from FIG. 1, and of a bearing unit 20b of the power tool 10b, when mounted in a main handle housing 14b of the power tool 10b, with the switching unit 16b in an unactuated state, wherein one of at least two handle housing shell elements 84b, 86b of the handle housing 14b has been removed. The power tool 10b has a structure that is at least substantially similar to that of the power tool 10a from FIG. 1. Reference may therefore be made, at least substantially, to the description of FIG. 1 in respect of a description, or features, of the power tool 10b of the further exemplary embodiment. The power tool 10b is likewise realized as a portable power tool 10b, which is constituted by an angle grinder 12b. The power tool 10b comprises at least the handle housing 14b, at least the switching unit 16b, which has at least one latch element 18b, arranged on the handle housing 14b, for actuating a switching element 36b of the switching unit 16b, and at least the bearing unit 20b, which is provided for mounting the latch element 18b so as to be at least movable relative to the handle housing 14b.

The bearing unit 20b is provided to ensure a travel movement of the latch element 18b along a distance having a value of greater than zero in every case, upon an actuation of the latch element 18b, starting from an end 24b of the latch element 18b that faces toward a connecting region 22b of the handle housing 14b, in the direction of a further end 26b of the latch element 18b that can be gripped and that faces away from the connecting region 22b. The bearing unit 20b is additionally provided to enable at least one pivot movement of the further end 26b of the latch element 18b that can be gripped and that faces away from the connecting region 22b into the handle housing 14b, as a result of an actuation of the latch element 18b. The bearing unit 20b in this case has at least one bearing element 28b, which is arranged at the end 24b of the latch element 18b that faces toward the connecting region 22b of the handle housing 14b. The bearing element 28b is additionally arranged on a side 32b of an actuating region 34b of the switching element 36b of the switching unit 16b that faces toward the connecting region 22b of the handle housing 14b. The actuating region 34b of the switching element 36b is constituted by a switching tappet of the switching element 36b. The bearing element 28b is realized as a pin-type bearing element 38b. In this case, the pin-type bearing element 28b is realized so as to be integral with the handle housing 14b. The bearing element 28b, realized as a pin-type bearing element 38b, is realized so as to be integral with one of the handle housing shell elements 84b, 86b of the handle housing 14b. In this case, a longitudinal axis of the bearing element 28b that runs at least substantially perpendicularly in relation to the direction of longitudinal extent 56b of the latch element 18b constitutes a pivot axis 118b of the latch element 18b. The bearing element 28b is realized so as to be rotationally symmetrical about the longitudinal axis of the bearing element 28b.

The latch element 18b has a bearing recess 154b, for receiving the bearing element 38b, realized as a pin-type bearing element 38b. The bearing recess 154b is arranged at the end 24b of the latch element 18b that faces toward the connecting region 22b. The bearing recess 154b in this case is realized as an oblong hole, in which the bearing element 28b engages when the latch element 18b has been mounted on the handle housing 14b.

It is also conceivable, however, for the bearing recess 154b to be of a different design, considered appropriate by persons skilled in the art, such as, for example, designed as a web-type guide element, etc. The bearing recess 154b, realized as an oblong hole, runs at least substantially parallelwise in relation to a direction of longitudinal extent 56b of the latch element 18b. The bearing recess 154b, as viewed along the direction of longitudinal extent 56b, has a maximum longitudinal extent that is at least twice as great as a maximum extent of the bearing element 28b along the direction of longitudinal extent 56b. Thus, by means of a combined action of the bearing element 28b and the bearing recess 154b, displaceability of the latch element 18b along the direction of longitudinal extent 56b can be achieved.

Furthermore, the bearing unit 20b has at least one movement guide element 50b, which comprises at least one movement guide path 52b having a course that is different from a pure rectilinear course. The movement guide path 52b in this case has an L-shaped course.

The movement guide path 52b thus has at least one limb 54b, which extends at least substantially transversely in relation to the direction of longitudinal extent 56b of the latch element 18b. In addition, the movement guide path 52b of the movement guide element 50b has a further limb 158b, which extends at least substantially parallelwise in relation to the direction of longitudinal extent 56b of the latch element 18b. The movement guide element 50b is provided to act in combination with a further bearing element 58b of the bearing unit 20b that engages in the movement guide element 50b, for the purpose of guiding the latch element 18b during a movement. The movement guide path 52b of the movement guide element 50b is realized as a guide slot. In this case, the guide slot is constituted by an L-shaped oblong hole.

The movement guide element 50b is realized so as to be integral with the latch element 18b. In this case, the movement guide element 50b is arranged at the end 26b of the latch element 18b that faces away from the connecting region 22b. The further bearing element 58b of the bearing unit 20b, which acts in combination with the movement guide element 50b when the latch element 18b has been mounted on the handle housing 14b, is likewise realized as a pin-type bearing element 156b. In this case, the further bearing element 58b, realized as a pin-type bearing element 156b, is realized so as to be integral with one of the handle housing shell elements 84b, 86b of the handle housing 14b. In addition, the further bearing element 58b is arranged on a side 160b of the actuating region 34b of the switching element 36b that faces away from the connecting region 22b. The switching element 36b is fixedly arranged in a receiving recess 104b of at least one of the handle housing shell elements 84b, 86b. The latch element 18b has a switching region 162b, for actuating the actuating region 34b, realized as a switching tappet, of the switching element 36b. The switching region 162b, as viewed along the direction of longitudinal extent 56b of the latch element 18b, is constituted by a region of the latch element 18b that is arranged between the movement guide element 50b and the bearing recess 154b, and that faces toward the handle housing 14b when the latch element 18b has been mounted on the handle housing 14b.

In addition, the switching unit 16b has at least one spring element 60b, which is provided to apply a spring force of the spring element 60b to the latch element 18b, in the direction of an initial position. The spring element 60a is provided to constitute a dead man's circuit function of the switching unit 16a. The spring element 60b is realized as a compression spring. It is also conceivable, however, for the spring element 60b to be of another design, considered appropriate by persons skilled in the art, such as, for example, designed as a tension spring, etc. In this case, the spring element 60b is supported, by one end, on at least one of the handle housing shell elements 84b, 86b of the handle housing 14b. By a further end, the spring element 60b is supported on the latch element 18b. The latch element 18b has a pin-type guide stud 116b for guiding the spring element 60b. The guide stud 116b is arranged at the end 24b of the latch element 18b that faces toward the connecting region 22b. A longitudinal axis of the spring element 60b runs at least substantially transversely in relation to the direction of longitudinal extent 56b of the latch element 18b, at least when the latch element 18b is in an initial position, in which the latch element 18b is unactuated.

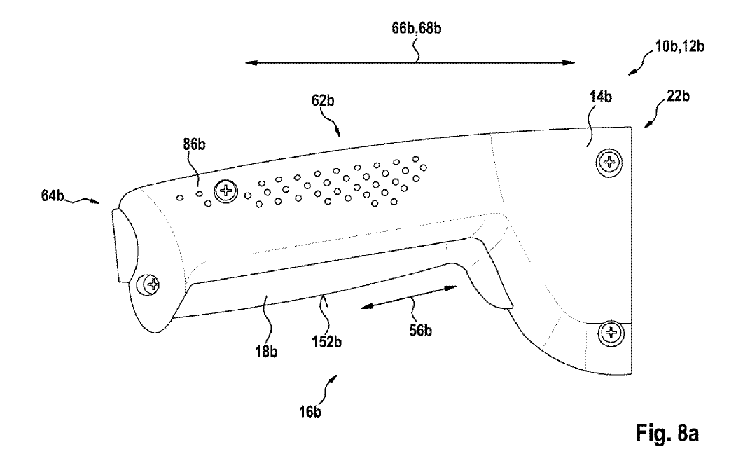

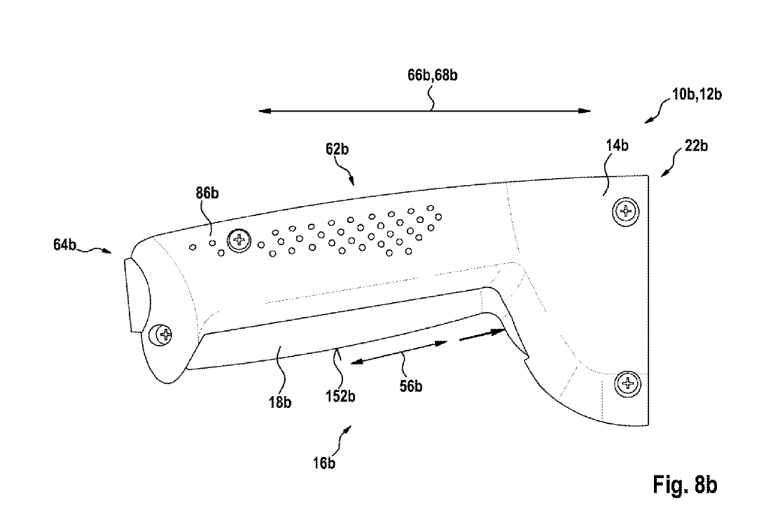

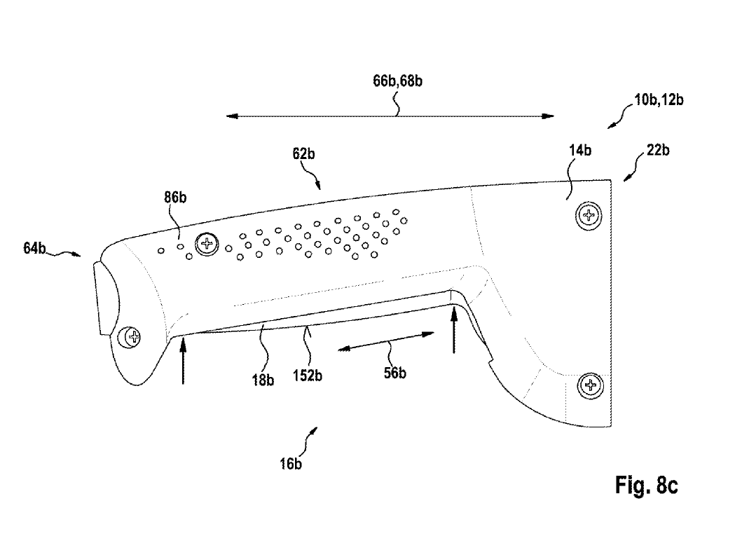

For the purpose of putting the portable power tool 10b into operation, the latch element 18b is moved by an operator, starting from an initial position of the latch element 18b (FIG. 8a), along the direction of longitudinal extent 56b of the latch element 18b, in the direction of the connecting region 22b of the handle housing 14b. As a result of this, a switch-on inhibitor unit 140b of the portable power tool 10b is deactivated. The switch-on inhibitor unit 140b is constituted by a combined action of the further limb 158b of the movement guide path 52b of the movement guide element 50b and of the further bearing element 58b. The combined action of the further limb 158b of the movement guide path 52b, when the latch element 18b is in the initial position, prevents, at least to a large extent, a movement of the latch element 18b in a direction running at least substantially transversely in relation to the direction of longitudinal extent 56b of the latch element 18b and running in the direction of the handle housing 14b.

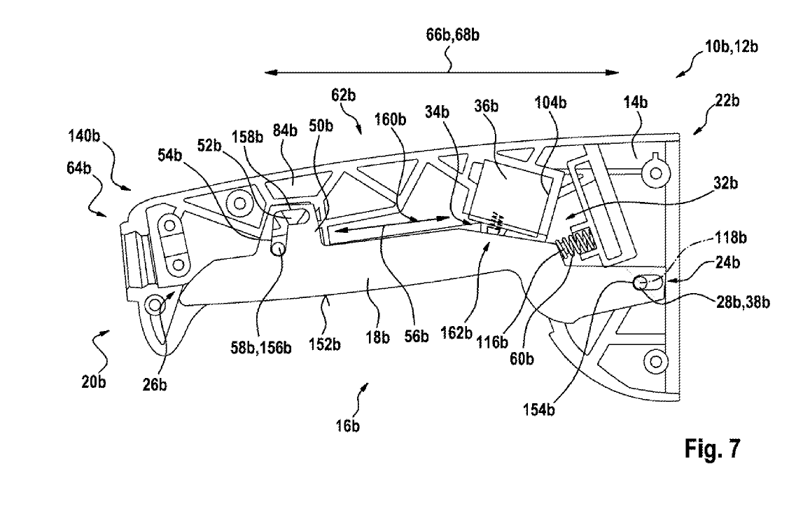

As a result of a movement of the latch element 18b along the direction of longitudinal extent 56b of the latch element 18b, the bearing recess 154b is moved relative to the bearing element 28b, until the bearing element 28b strikes against, or bears against, an edge region of the latch element 18b that delimits the bearing recess 154b and that is arranged on a side of the bearing recess 154b facing away from the connecting region 22b. After an operator has moved the latch element 18b along the direction of longitudinal extent 56b of the latch element 18b (FIG. 8b), the further bearing element 58b and the limb 54b of the movement guide path 52b of the movement guide element 50b, which limb extends at least substantially transversely in relation to the direction of longitudinal extent 56b of the latch element 18b, are in alignment (FIG. 7).

Thus, a pivot movement of the end 26b of the latch element 18b that can be gripped and that faces away from the connecting region 22b, about the pivot axis 118b, as a result of an action of force of an operator upon the latch element 18b, in a direction running at least substantially transversely in relation to the direction of longitudinal extent 56b of the latch element 18b, can be effected into the handle housing 14b (FIG. 8c), until the further bearing element 58b strikes against, or bears against, an edge region of the movement guide element 50b that delimits the limb 54b of the movement guide path 52b (FIG. 7). In this case, the actuating region 34b, realized as a switching tappet, of the switching element 36b is actuated by means of the switching region 162b of the latch element 18b, as a result of the pivot movement of the latch element 18b about the pivot axis 118b.

In this case, by means of the bearing unit 20b, a lever ratio, between the actuating region 34b of the switching element 36b and the latch element 18b, is achieved that is greater than 1 to 3.1. The lever ratio corresponds to a length of a distance measured from the pivot axis 118b of the latch element 18b as far as a central axis of the actuating region 34b, realized as a switching tappet, of the switching element 36b, in relation to a length of a distance measured from the pivot axis 118b of the latch element 18b as far as a point located in a central plane of an operating surface 152b of the latch element 18b.

1. A power tool, comprising:
at least one handle housing including (i) at least one a switching unit that has at least one latch element arranged on the handle housing and (ii) at least one bearing unit configured to mount the latch element so as to be at least movable relative to the handle housing,
wherein the bearing unit is further configured to ensure a travel movement of the latch element along a distance having a value of greater than zero in every case, upon an actuation of the latch element, starting from an end of the latch element that faces toward a connecting region of the handle housing, in the direction of a further end of the latch element that is configured to be gripped and that faces away from the connecting region.

2. The power tool as claimed in claim 1, wherein the bearing unit has at least one bearing element that is arranged at the end of the latch element that faces toward the connecting region of the handle housing.

3. The power tool as claimed in claim 1, wherein the bearing unit has at least one bearing element that is arranged on a side of an actuating region of a switching element of the switching unit that faces toward the connecting region of the handle housing.

4. The power tool as claimed in claim 1, wherein the bearing unit has at least one bearing element that is configured as a pin-type bearing element.

5. The power tool as claimed in claim 4, wherein the pin-type bearing element is configured so as to be integral with the handle housing.

6. The power tool as claimed in claim 1, wherein the bearing unit comprises at least one lever mechanism unit.

7. The power tool as claimed in claim 6, wherein the lever mechanism unit is configured as a parallelogram lever mechanism unit.

8. The power tool as claimed in claim 1, wherein the bearing unit comprises at least one lever mechanism unit, the lever mechanism unit having at least one lever bearing element that actuates an actuating region of a switching element of the switching unit in dependence on a movement of the latch element.

9. The power tool as claimed in claim 1, wherein the bearing unit comprises at least one lever mechanism unit, the lever mechanism unit having at least one lever bearing element that is movably connected to the latch element, at the end of the latch element that faces toward the connecting region of the handle housing.

10. The power tool as claimed in claim 8, wherein the lever mechanism unit has at least one further lever bearing element, arranged in a movable manner on the latch element, the further lever bearing element further arranged in a movable manner on a further bearing element of the bearing unit that is arranged on a side of an actuating region of a switching element of the switching unit that faces toward the connecting region of the handle housing.

11. The power tool as claimed in claim 1, wherein the bearing unit has at least one movement guide element that comprises at least one movement guide path having a course that is different from a pure rectilinear course.

12. The power tool at least as claimed in claim 1, wherein the bearing unit has at least one movement guide element that comprises at least one movement guide path having an L-shaped course.

13. The power tool at least as claimed in claim 1, wherein the bearing unit has at least one movement guide element that comprises at least one movement guide path having at least one limb that extends at least substantially transversely in relation to a direction of longitudinal extent of the latch element.

14. The power tool at least as claimed in claim 1, wherein the bearing unit has at least one movement guide unit that is configured to act in combination with a bearing element of the bearing unit that engages in the movement guide element so as to guide the latch element during a movement.

15. The power tool as claimed in claim 11, wherein the movement guide path of the movement guide element is configured as a guide slot.

16. The power tool as claimed in claim 11, wherein the movement guide element is configured so as to be integral with the latch element.

17. The power tool as claimed in claim 11, wherein the bearing unit is configured to enable at least one pivot movement, of a further end of the latch element that is configured to be gripped and that faces away from the connecting region, into the handle housing.

18. The power tool as claimed in claim 1, wherein the switching unit has at least one spring element configured to apply a spring force of the spring element to the latch element, in the direction of an initial position.

19. A power tool switching device of a power tool, comprising:
at least one switching unit; and
at least one bearing unit configured to mount a latch element of the switching unit in a movable manner relative to the power tool,
wherein the bearing unit is further configured to ensure a travel movement of the latch element along a distance having a value of greater than zero in every case, upon an actuation of the latch element, starting from an end of the latch element that faces toward a connecting region of the power tool, in the direction of a further end of the latch element that is configured to be gripped and that faces away from the connecting region.

20. The power tool as claimed in claim 1, wherein the power tool is configured as an angle grinder.
